(19) United States
(12) Patent Application Publication
(10) Pub. No.: US 2008/0316004 A1
(43) Pub. Date: Dec. 25, 2008

(54) Powerline communication apparatus and methods

(76) Inventor: Frederick J. Kiko, Carlsbad, CA (US)

Correspondence Address: Robert F. Gazdzinski;GAZDZINSKI & ASSOCIATES, 11440 West Bernardo Court, Suite 375, San Diego, CA, 92127, US

(21) Appl. No.: 11/820,256

(22) Filed: Jun. 19, 2007

(51) Int. Cl. G05B 11/01

(52) U.S. Cl. 340/310.13; 340/310.11; 340/310.17

(57) ABSTRACT

A system, associated components, and methods for improving powerline communications between electrical devices in, for example, a home or office setting. In one embodiment, a control module provides electrical command signals to a plurality of devices coupled to a powerline. A transformer operatively coupled to the control module and is configured to capacitively couple through its center tap to a non-signal line to provide a communication path to the plurality of devices. The transformer configuration provides a low noise communication path for the electrical command signals. Methods for installing and operating the aforementioned system and components are also described.

### COPYRIGHT

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The present invention relates generally to the field of powerline communication, and specifically to a powerline communication system (and its individual components) that may be used in a home, office, or other premises.

2. Description of Related Technology

Traditional approaches to powerline communication (e.g., home or office) include applications such as control of lighting and appliances, as well as sending data or broadband data, video or audio. Typically powerline communication systems generally involve any of the following control components or systems: i) switching power supplies installed in an existing lighting system, (ii) ballasts to efficiently switch on and off appliances during designated time intervals and/or provide variable power control to change lighting conditions, and (iii) variable speed motor controls to control output power and power efficiency characteristics of electronic and/or mechanical devices in an home, warehouse, and product distribution center. Powerline command communication systems include for example X10, C-Bus, and Lonworks. New establishments as well as existing homes and premises may require powerline command communication systems to be installed.

Command systems in many instances integrate different manufacturers' products into a single ad hoc system. This integration almost always introduces an element of complexity into the system, since the components forming the system each have their own operating environments, control functions and the like. While some “high-end” customers are satisfied with such complex “composite” systems, many others yearn for a simpler, more reliable, and more intuitive approach.

Many of the deficiencies relating to the reliability of such prior art systems concerns the control of many different manufacturer's remote control technologies such as, e.g., infrared (IR) systems. Typically an IR control system must be installed and connected to each of the manufacturer's IR input LEDs using some fastening mechanism (e.g., double-sided tape or Velcro attachments) to hold a device in place, with cabling routed to a master controller. A Universal remote control added and programmed by a technician to control at least a portion of the devices. Most such technician-installed systems require repeat visits to re-program the system, in one example, when the system that is toggled on/off is thrown out of a preferred sequence, or, in a second example, when user(s) unknowingly erase or corrupt system files. These installations may also be unsightly, and/or require significant (and often irreversible) modifications to the user's premises.

The HomePlug organization is an industry trade group for powerline communication including approximately 50 entities to define powerline communication specifications. HomePlug 1.0 is a specification for a home networking technology that connects devices to each other through power lines in a home. HomePlug certified products connect PCs and other devices that use Ethernet, USB, and 802.11. Many devices made by alliance members have HomePlug built in and connect to a network upon plugging the device into a wall socket in a home with other HomePlug devices. Signal interference, from surge protectors, extension cords, outlet strips and/or other proximately located devices, including the high-frequency signals, is an on-going concern of the HomePlug alliance.

Similarly, HomePlug AV (HPAV) is a new generation of technology from the HomePlug Powerline Alliance. HPAV can be for example embedded in consumer electronics or computing products, and provides high-quality, multi-stream, entertainment-oriented networking over existing AC wiring. Users can avoid having to install new wires in their premises by using devices having built-in HomePlug technology. HPAV uses advanced PHY and MAC technologies that provide a 200 Mbps (million bits per second) class powerline network for inter alia video, audio and data. The Physical (PHY) Layer utilizes this 200 Mbps channel rate to provide a 150 Mbps information rate to provide communications over noisy power line channels.

Powerline communications communicate across line and neutral leads and pass through system current controlling devices, such as near circuit breakers and two split-phase lines. In many homes, coupling across the two split-phase lines is realized externally by a device outside the home, e.g., a pole transformer. In other homes, sub-panels of circuit breakers may introduce additional losses (and lower power efficiency) due to an increased travel distance to a pole transformer. Furthermore, electrical losses and noise levels introduced by additional bridge circuits, phase couplers, repeaters, and the like needs to be reduced to improve powerline communications.

Furthermore, many users of such prior art systems simply stop using them due to high level of complexity and expertise required for proper operation. This problem is especially acute for more senior segments of the population, who may not have the intimate level of familiarity or understanding of computers and electronic systems that younger generations have.

Methods for remotely controlling devices and systems in a home or business environment are also known in the prior art. Some of these methods employ signaling over AC power lines, while others employ signaling over communications channels or media installed specifically to transport the control signals.

Generally, the prior art signaling controller (whether AC power line or another type) includes its own control and operating environment. A user interface may further be included with the signaling controller to remotely control the home automation system using a remote device. However, as previously described, these AC power distribution-based systems lack the desired ease of installation, control and operation, as well as lacking integration (centralization) with other control functions of the user's premises, and result in high system losses and high noise levels.

Hence, what is needed is a greatly simplified yet fully functional premises powerline communication and control system and associated methods of operation. Such system and methods would also ideally allow a user to perform the installation of the system themselves (or with minimal assistance), and also not require any significant modification to the premises infrastructure such as running cabling, electrical system modifications, drywall or plumbing work, etc.

The ideal system would also be highly modular in nature, such that each user could configure their premises (and equipment operating therein) according to their particular desires and equipment configuration. Furthermore, this system should reduce power losses and noise level associated with bridging circuits, e.g., circuit breakers, at one or more electrical panels. This modularity would also include the ability to add more or different functions over time without having to modify the rest of the system.

### SUMMARY OF THE INVENTION

The present invention satisfies the aforementioned needs by providing improved apparatus and methods for, inter alia, automation within a home, office, or other premises.

In a first aspect of the invention, an improved apparatus for use on premises is disclosed. In one exemplary embodiment, a controller device provides electrical command signals to a plurality of devices coupled to a powerline. One variant uses a transformer operatively coupled to the controller device to capacitively couple through its center tap to a non-signal line to provide a communication path to the plurality of devices.

In another variant, the non-signal line may be a safety ground line. In yet another variant, the controller comprises a HomePlug command and control (HPCC) module.

In a second aspect of the invention, an improved apparatus that operates as a controller device for use in a lighting or electrical system is disclosed. In one exemplary embodiment, the apparatus includes a controller device to communicate electrical signals to a plurality of electrical devices coupled to a power line and a transformer having a primary and a secondary winding and turns ratio a/b.

In a third aspect of the invention, a frequency dependant module for use in premises is disclosed. In one exemplary embodiment, a control module is provided that provides electrical command signals to a plurality of devices coupled to a powerline. A transformer operatively coupled to the control module and configured to provide a frequency dependant turns ratio to the plurality of devices to provide an increased voltage level for control module operation in an upper frequency band than that of a lower frequency band.

In a fourth aspect, an improved “noise filtering” module for use with the system is disclosed. In one exemplary embodiment, a command control module communicates with at least one electrical device. A notch detection circuit communicates a sweep signal across a designated frequency band with the at least one electrical device to measure receive input response and to determine an impedance across the designated frequency band. An appliance filter shifts a low impedance band within the designated frequency band to a frequency band outside the designated frequency band.

In a fifth aspect of the invention, an improved electrical device is disclosed. In one exemplary embodiment, the device comprises a small-size and low-cost driver circuit which may be used with the aforementioned system for, inter alia, reducing power consumption and improving reliability of upper frequency band communication.

In a sixth aspect of the invention, an improved method of installing the foregoing system and associated components is disclosed. The method generally comprises communicating with a command control module to a plurality of electrical devices; scanning with a noise detection circuit a power level of a receive circuit coupled to the command control module; and signaling a self-installer to place a first appliance filter on at least one of the plurality of electrical devices detected as having a high noise level.

In one embodiment, the method may further include the steps of (i) measuring a level of electrical signals from inside a unit communicated outside of the unit and (ii) signaling a self-installer to place a second appliance filter on at least one of the plurality of electrical devices detected communicating a high leakage signal outside of the unit.

In one variant, the second appliance filter may include at least one ferrite core adapter, or at least two ferrite core adapters disposed about external connectors; and a capacitive device adapted to operatively couple between the least two ferrite core adapters.

These and other aspects of the invention will be readily appreciated by those of ordinary skill provided the present disclosure.

### BRIEF DESCRIPTION OF THE DRAWINGS

The features, objectives, and advantages of the invention will become more apparent from the detailed description set forth below when taken in conjunction with the drawings, wherein:

FIG. 1a is a functional block diagram of a first exemplary configuration of a communication apparatus over neutral and the safety ground according to the present invention.

FIG. 1b is a functional block diagram of a second exemplary configuration of using the safety ground of a communication apparatus according to the present invention.

FIG. 1c is a schematic representation of ferrite core halves that may be utilized in the communication apparatus of FIGS. 1a, 1b.

FIG. 2 is a schematic representation of a communication apparatus utilizing a drive circuit according to the present invention to allow communication through a high leakage sector wound power transformer.

FIG. 3 is a functional block diagram of frequency compensated communication drive apparatus according to the present invention.

FIGS. 4a and 4b are perspective assembly and top plan views, respectively, of outside receptacle filter according to the present invention.

FIG. 4c is a schematic representation of plug-in appliance filter according to the present invention.

FIG. 4d is a section of an exemplary filter apparatus (including filter of FIG. 4c) according to the invention, taken along line 4d-4d.

FIG. 4e is a bottom plan view of the apparatus of FIG. 4d.

FIG. 4f is a schematic representation of a whole premises (e.g., meter) noise blocking filter according to the present invention.

FIG. 4g is a perspective assembly view of an exemplary configuration of a filter apparatus incorporating the whole premises noise blocking filter of FIG. 4f.

FIG. 5 is a schematic representation of a multi-phase repeater according to the present invention.

FIG. 6 is a schematic representation of an automated impedance selection apparatus according to the present invention.

FIG. 7 is an x-y plot illustrating impedance as a function of frequency for various length cables attached to an electrical device according to the present invention.

FIGS. 8a, 8b are versions of a power-saving active controlled output impedance driver circuit according to the present invention.

FIG. 9 is a flow diagram illustrating how self-installer detects frequency notches according to the present invention.

### DETAILED DESCRIPTION OF THE INVENTION

Reference is now made to the drawings wherein like numerals refer to like parts throughout.

As used herein, the term “signal conditioning” or “conditioning” shall be understood to include, but not be limited to, signal voltage transformation, filtering and noise mitigation or elimination, current limiting, sampling, signal processing, and time delay.

As used herein, the term “integrated circuit” shall include any type of integrated device of any function, whether single or multiple die, or small or large scale of integration, and irrespective of process or base materials (including, without limitation Si, SiGe, CMOS and GAs) including without limitation applications specific integrated circuits (ASICs), field programmable gate arrays (FPGAs), digital processors (e.g., DSPs, CISC microprocessors, or RISC processors), so-called “system-on-a-chip” (SoC) devices, memory (e.g., DRAM, SRAM, flash memory, ROM), mixed-signal devices, and analog ICs.

The term “processor” is meant to include any integrated circuit or other electronic device (or collection of devices) capable of performing an operation on at least one instruction including, without limitation, reduced instruction set core (RISC) processors, CISC microprocessors, microcontroller units (MCUs), CISC-based central processing units (CPUs), and digital signal processors (DSPs). The hardware of such devices may be integrated onto a single substrate (e.g., silicon “die”), or distributed among two or more substrates. Furthermore, various functional aspects of the processor may be implemented solely as software or firmware associated with the processor.

As used herein, the terms “program”, “programmable”, and “computer program” are meant to include any sequence or human or machine cognizable steps which perform a function. Such program may be rendered in virtually any programming language or environment including, for example, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.) and the like, as well as in firmware or other implementations.

As used herein, the terms “network” and “bearer network” refer generally to any type of telecommunications or data network including, without limitation, data networks (including MANs, WANs, LANs, WLANs, internets, and intranets), hybrid fiber coax (HFC) networks, satellite networks, and telco networks. Such networks or portions thereof may utilize any one or more different topologies (e.g., ring, bus, star, loop, etc.), transmission media (e.g., wired/RF cable, RF wireless, millimeter wave, optical, etc.) and/or communications or networking protocols (e.g., SONET, DOCSIS, IEEE Std. 802.3, ATM, X.25, Frame Relay, 3GPP, 3GPP2, WAP, SIP, UDP, FTP, RTP/RTCP, H.323, etc.).

As used herein, the term “wireless” includes, but is not limited to, IS-95, CDMA2000, Wideband CDMA (WCDMA), Bluetooth™, IrDA interface, IEEE Std. 802.11(a) or (g), Wireless Application Protocol (WAP), GPRS, GSM, TDMA (e.g., IS-54 or 136), UMTS, third-generation or “3G” systems such as 3GPP and 3GPP2, ultrawideband (UWB) systems such as TM-UWB or 802.15, WiMAX, satellite systems, or any other of myriad data communication systems and protocols well known to those of skill in the communications arts.

As used herein, the term “digital subscriber line” (or “DSL”) shall mean any form of DSL configuration or service, whether symmetric or otherwise, including without limitation so-called “G.lite” ADSL (e.g., compliant with ITU G.992.2), RADSL: (rate adaptive DSL), VDSL (very high bit rate DSL), SDSL (symmetric DSL), SHDSL or super-high bit-rate DSL, also known as G.shdsl (e.g., compliant with ITU Recommendation G.991.2, approved by the ITU-T February 2001), HDSL: (high data rate DSL), HDSL2: (2nd generation HDSL), and IDSL (integrated services digital network DSL), as well as In-Premises Phoneline Networks (e.g., HPN).

Additionally, the terms “site”, “premises” and “structure” as used herein shall include any location (or group of locations) having one or more functions capable of using one or more aspects of the present invention including, without limitation, residential houses, apartments, trailers, watercraft (e.g., “houseboats”), motor homes, offices, and businesses.

As used herein, the term “display” means any type of device adapted to display information, including without limitation LCDs, TFTs, plasma displays, LEDs, CRTs, FEDs, and fluorescent devices.

As used herein, the term “controller” generally refers to an apparatus or algorithm providing one or multiple control functions to itself or another device. Examples of controllers include servers, schedulers, microcontrollers, PID controllers, and so forth.

As used herein, the terms “powerline” and “powerline communications” refer to any technology which is used to transfer data or signals over a power distribution system, including without limitation UPB, HomePlug, HomePlug a/v, and X-10 technologies.

As used herein, the term “UPB” or Universal Powerline Bus refers to one exemplary instance of technologies which impose digital or analog signals or pulses onto AC waveforms or DC power delivery systems, such as for example the well known UPB approach. set forth in “Universal Powerline Bus: The UPB System Description”, Version 1.1 dated Sep. 19, 2003, incorporated herein by reference in its entirety.

Lastly, the term “homeplug” as used herein is meant specifically to include devices and systems compliant with the HomePlug™ Powerline Alliance Specification for powerline-based home networks (including the more recent HomePlug A/V), and generally to include all other comparable devices adapted for powerline networking.

### Overview

The present inventions seek to improve the communication process of a premises (e.g. home, office, warehouse, distribution center, commercial building) process through a variety of advantageous design features, including: (i) reducing system losses and decreasing noise figure as compared to conventional powerline communication systems; (ii) reducing complexity and cost of installation of the technology through modular and easily installable components, and use of existing structure wiring (e.g., electrical power wiring, telecommunications, and cable television system wiring) to the maximum extent practicable; and (iii) providing a high level of system scalability so that each particular installation may be readily configured to meet the customer's needs at the lowest cost and with the least complexity, while also simultaneously permitting expansion to cover literally every type of function relating to the structure including, e.g., HVAC/environmental control, security, entertainment, energy conservation and management, and safety.

The present invention provides apparatus and methods for achieving these goals. It is advantageously made extremely simple to install and use, thereby providing greater accessibility across a wide stratum of different users. Also, minimal changes to the user's premises so that system costs, including installation and learning curves for new users will be minimized.

The present invention is also made quite comprehensive; i.e., it addresses a wide range of potential powerline communication applications and issues that may be encountered by a user or homeowner, thereby obviating the need of such persons to piece together a mixed or heterogeneous system (e.g., from multiple vendors) as in the prior art. The present invention (with proper additions by the user) addresses the whole spectrum of communication needs, including providing reduced leakage coupling transformers, frequency dependant coupling circuit to improve transmission speed, blocking filters for outside power line receptacles, filters to reduce transmitted appliance switching noise, blocking filters for reducing noise that arrives from outside and appears inside a premises, phase repeaters, automated impedance matching sections, drivers amplifiers with active output resistance, attenuation notch detection circuits, detection circuit to instruct a self-installer where to place an appliance filter, isolation and conservation, remote monitoring, energy conservation, multimedia delivery, computer networking and distribution, lighting control, and a plethora of other such applications.

### Powerline Communication System

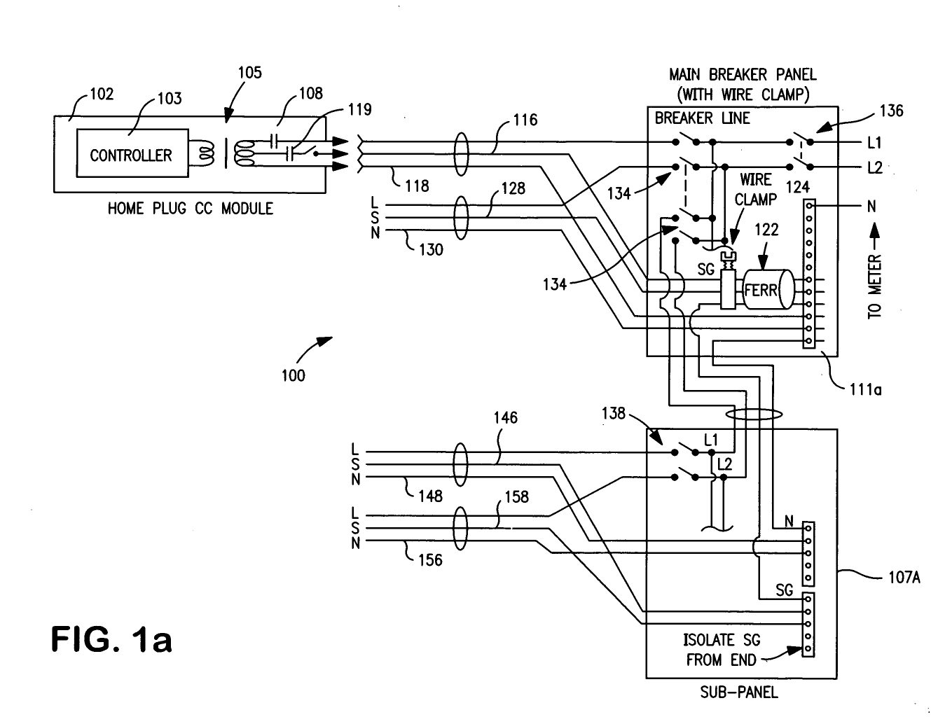

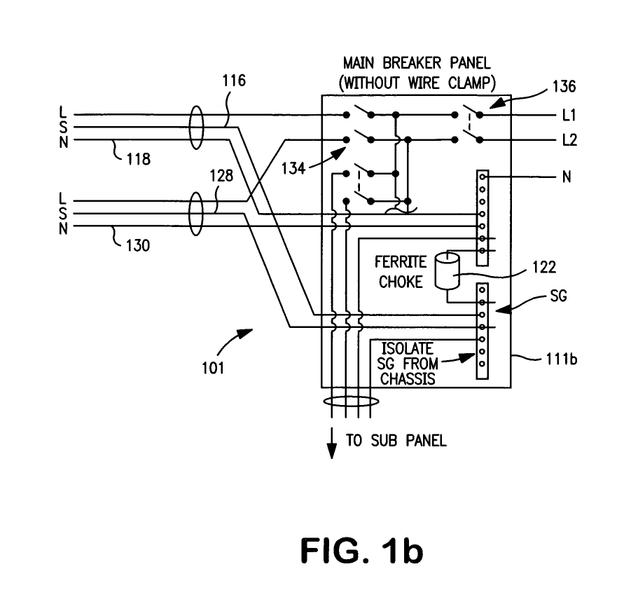

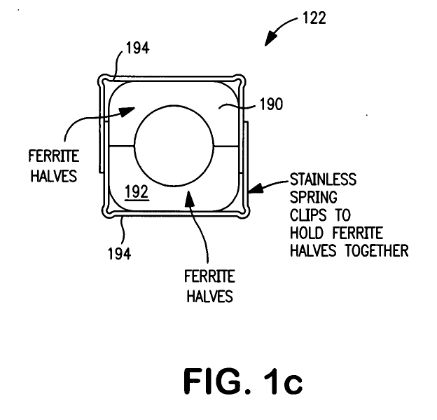

Referring now to FIGS. 1a, 1b, exemplary embodiments of powerline systems 100, 101 utilizing various facets of the present invention is described in detail.

It will be recognized that while one aspect of the present invention comprises an integrated and coordinated system of the type represented by the exemplar of FIG. 1a, 1b, the various aspects of the invention may be employed either alone or in combination with one or more other aspects of the invention to achieve the desired result. Hence, advantageously, the invention is inherently modular and completely scalable. More or less components of a particular type may be used, as well as more or less types of different components.

It will further be recognized that while the terms “home” and “consumer” may be used herein in association with one or more aspects and exemplary embodiments of the invention, the invention is in no way limited to such applications. The various aspects of the present invention may be applied with equal success in, inter alia, small or large business (e.g., so-called “enterprise” systems), industrial, and even military applications if desired.

Moreover, while exemplary embodiments of the invention are described in terms of HomePlug (HP) technology, the invention is in no way so limited, and accordingly may be used in any number of other environments and applications.

As previously discussed, the present invention seeks to improve and simplify the (e.g. home) process through a variety of advantageous design features, including: (i) connecting most of the functions with a compact, unitary controller (or alternatively scheduler or controller); (ii) reducing the complexity and cost of installation of the technology through modular and self-installable components, and use of existing structure wiring to the maximum extent practicable; (iii) providing a high level of system scalability so that each particular installation may be readily configured to meet the customer's needs at the lowest cost and with the least complexity, while also simultaneously permitting expansion to cover other functions relating to HVAC/environmental control, security, entertainment, energy conservation and management, and safety; and (iv) providing increased reliability. Various aspects are now described in detail with reference to FIGS. 1a, 1b.

### SG/N Powerline Communication

As shown in FIGS. 1a, 1b, the exemplary systems 100, 101 generally comprise a plurality of components, including inter alia: a controller (or controlled) device 103 (such as a server device, lamp dimmer, etc.); a plurality of devices (e.g., HomePlug devices or other compatible devices); a center tap transformer 105 which is included in HomePlug modules; and a network interface (not shown). Other components for the systems 100, 101 may include the following: a wire clamp 124 (to create an isolated summing node to tie together safety ground lines); a ferrite core 122 and one or more capacitors 108, 109 which may be part of each HomePlug node; master breaker 136, sub-breaker 138; and loop circuit breakers 134.

As will be described in greater detail below, these components interact with the controller device 103 if present (and each other to varying degrees) in order to effectuate the desired control of the various devices within the structure, where examples of device functionality includes any or all the following: lighting, telephony, video systems, security cameras, appliances (including, e.g., water heater/water-on-demand system, dryer, oven, fan, HVAC, etc.), personal/home electronics, and sprinkler systems. All of the electrical items that are powered may generally be controlled to some extent, to include literally any type of electronic or electro-mechanical devices capable of receiving control inputs.

It is noted that in the present context, the term “control” may be as simple as control of signals and/or power applied to a device (i.e. turning AC or DC power to the device on or off), or as complex as processor/microcontroller-based, algorithmically controlled, multivariate operation. Myriad other types of control schemes are possible consistent with the invention. “Control” may also include the prevention of one or more occurrences. Hence, the term “control” shall be construed broadly in the present context.

For improved entertainment and media value, the systems 100, 101 may also be configured to store and distribute audio and video media and applications (whether as discrete files, or streamed content) as well as accept TV antenna, CATV/HDTV, Satellite RF signal input (via a coupled network), and even streamed Internet content. Downloads from DVDs, CDs, digital cameras, digital video camera, and other client devices may also be stored on the controller device 103 (or other associated storage device either on or off-premises, such as a RAID or comparable mass storage device, or dedicated Internet-based storage system) for later distribution to any monitor, computer, or network node in the house, including wireless distribution points. Indigenous audio, video and sensor data may also be delivered directly and/or stored for later delivery, streaming or playback. The controller device 103 may be integrated with other media functions also, such as by being co-located or including a DSTB, satellite receiver, etc. These devices may also utilize the modular form factors described subsequently herein.

It will be appreciated that while the illustrated embodiments 100, 101 of FIGS. 1a, 1b are cast at least partly in terms of “wired” systems such as the indigenous AC power wiring and other cable interfaces, much of the functionality described herein may be accomplished using well known wireless interface technology. The various wired approaches described below, however, have the advantages of ultra-low cost and simplicity of installation (and operation) as well as reliability, although wireless systems and interfaces are becoming much more ubiquitous. For example, in one variant of the present invention, the controller device 103 and the network 168 may be configured with short-range wireless interfaces such as e.g., those compliant with the Bluetooth or IrDA specifications, thereby obviating a direct wiring run from the HPCC module 102 to the local control device or sensor. This approach adds significant flexibility, yet increases the cost of the HPCC module 102 (and also the controlled components).

Furthermore, while certain embodiments are described in terms of an exemplary HomePlug protocols, the use of a particular protocol within a particular device is completely flexible, and other such protocols or technologies may be substituted.

In terms of security, the devices may be cameras located around the site in order to provide monitoring. As used herein, the term “camera” may include not only visual band (optical) cameras, but also non-visual band (e.g., IR or millimeter wave) devices, and also may include CCD or CMOS based devices. For example, in a front porch area of a house, screw-in flood lights and outside cameras with motion detection for event recording are coupled to the system, thereby making their data viewable on any monitor within the structure (or a remote monitoring site such as a security monitoring facility, or even a client device) with Internet or other network access. An upstream (OOB) DOCSIS channel of the CATV system may also be used for this purpose. In one exemplary configuration, hand-held client devices (including cell phones with video/picture reception capability, such as the Sprint “Vision” technology) are utilized in conjunction with the system to provide such remote viewing.

Additionally, door and window locks (and position or other associated sensors such as electrical or optical/IR continuity) may be controlled as part of the security features of the system. Optionally, a front door thumbprint and/or voice recognition system of the type well known in the security arts may be coupled to the systems 100, 101 so as to control premises entry or access (and even control of the systems 100, 101 themselves). For further improved safety, one or more of the cameras of the systems 100, 101 include smoke, heat and/or (natural) gas detectors, emergency lights and/or alarm speakers for broadcasting audible and visual alarms throughout the house. Alerts may also be distributed via the various monitors, TVs, wall plate LCDs, and cellular phones or other connected devices. Such alerts may include very basic “binary” information (e.g., alert or no alert, etc.), and/or more sophisticated content such as the location of the fire or gas leak. The various system alarms may also be configured to be adaptive; e.g., to change volume and tones according to either a predetermined pattern (such as a repetitive, sweeping increase in both volume and frequency, or a simultaneous broadband acoustic emission), or deterministically based on one or more input criteria (such as continued detected IR signature within the structure) to ensure it may be seen and/or heard by everyone.

The systems 100, 101 may also provide significant benefits in terms of managing water uses (such as sprinklers, hot water heating, etc.). The controller device 103 is optionally programmed to know the season, and adjust the watering times, but also monitor the actual moisture in the ground by adding sensors to the front, rear, and sides of the house and adjust the sprinkler times and/or days. The sprinkler controller may readily be added to replace an existing controller by simply transferring the existing controller leads to the present controller. A rain gauge may also be connected to the controller to modify the watering schedule, and a water pressure sensor may be added to sense the presence of a defective leaking sprinkler head or other system rupture.

One benefit of the systems 100, 101 involve using a neutral (N) lines (e.g., such as lines 118, 130, 148, 156) and the common (e.g., safety ground (SG)) lines (e.g., such as lines 116, 128, 146, 158) for communication between the controller 103 to the devices. This SG/N transmission is realized by modifying the HPCC module 102 or other such powerline modules. As shown in FIGS. 1a, 1b, a conventional coupling transformer (not shown) within the Home Plug Central Control Module (HPCC) 102 has been replaced by a center tap transformer 105. The center tap transformer 105 is capacitively coupled (e.g., through capacitor 109) to a common line (such as lines 116, 128, 146, and 158) to provide a benefit of signal transmission using the common lines (e.g., safety ground lines) and the neutral lines. Furthermore, the HPCC may communicate even on the largest premises or even with circuit breakers tripped, such as 134 being tripped (e.g., when any of the circuit breakers 134 are in “open” position), or with loss of power because the SG/N lines do not contain any circuit breakers.

In one embodiment, the SG/N lines transmit signals between the HPCC module 102 and a device. The HPCC module 102 communicates, for example, using SG/N lines to the device(s). Furthermore, the HPCC module 102 may communicate, for example, using L/N to one device and L/N line to another device depending on the position of the switch 136. Furthermore, both SG/N and L/N may both be utilized; thus, the present embodiments 100, 101 provide universal compatibility. Both L/N lines may be selected from command communication in one embodiment.

The system 100 ties together the common lines (e.g., bare safety ground lines) using a wire clamp 124, such as a standard wire clamp, and inserts an inductive element (e.g., a ferrite core 122 being clamped over the bare safety ground lines) between the wire clamp 124 and between at least one neutral (N) line (e.g., such as any of lines 118, 130, 148, 156) to create an isolated summing safety node at typical HomePlug frequencies (but negligible at 60 Hz or similar power frequencies). The isolated summing node (located at the connection to the wire clamp 124) couples SG lines (e.g., lines 116, 128, 146, 158). Consequently, if one or more of the coupled SG lines become loose and/or broken, non-broken and/or non-loose SG lines provide a connection to a neutral line (through the ferrite core 122) and to another SG line. In one variant, the ferrite core may be a split (shown in FIG. 1c as half cores 190, 192) secured over the bare safety ground lines using one or more clamps 194 (e.g., stainless steel spring clamps or another mechanism). In this variant, a self-installer or user may readily retrofit bare safety ground lines and form an isolated summing node without uninstalling (e.g., unscrewing) the bare safety ground wires from the neutral lines.

In addition, larger premises, including commercial property (such as office buildings, warehouses, multi-unit dwellings) and the like will benefit from the wire clamp 124 and the ferrite core 122 arrangement even with one or more sub-panel(s) (e.g., panel 107a) that connect to a main panel (e.g., panel 11a). A ferrite choke 122 (shown in FIG. 1b) may be utilized at each sub-panel (e.g., sub-panel 107a) and SG lines may be routed to any or all panels (e.g., panel 111b). For new building construction, the SG lines may be routed through a wire clamp (such as the wire clamp 124) and a ferrite choke (such as choke 122) to the N line on the main panel (such as panel 111a) or a sub-panel (such as panel 107a). In another variant, each panel (such as panels 107a) may be equipped with a second ground strip that is isolated from a system chassis and Neutral lines. In this variant, a second ground strip may be mounted to the system chassis using, for example, one or more insulated standoffs or insulating washers positioned over mounting screws for the second ground strip.

Other benefits of SG/N communication include substantially reduced noise voltage produced as compared with L/N communication. In particular, SG/N communication may have a noise floor at least 6 dB less than the noise floor for L/N communication. Furthermore, SG/N described above does not have phase coupling issues like that L/N communication. Secure communications using SG/N lines may be provided, e.g., for health and safety reasons, when circuit breakers (such as 134) are “open”. Furthermore, the topology in embodiment 100 and 101 allows HPCC to coexist with other systems including: HP 1.0, HP Turbo, HPAV (HomePlug Audio Video), and X10.

The exemplary topology is further capable of producing lower operating loss (than typical L/N communication) from plugged-in appliances because the plug-in appliances do not present signals or place any load impedance (that significantly degrades performance) across the SG/N lines. Furthermore, this exemplary topology is amendable to large and small premises, wherein several sub-panels may be utilized together using this topology with a wire clamp and the inductance element. Energy consumption within the monitored premises may be reduced by measuring usage, and managing when certain appliances are used such that the most favorable rates are applied. For example, if differential kWh rates are in place as a function of time of day, or if rolling blackouts are imminent, high-consumption activities (such as electric clothes dryer operation) may be automatically deferred until lower rates are in effect. Additionally, auto-shutoff of room lights, and use of power-sense technology on units supplying power to enlighten the home resident on power usage on the particular appliances, may also be employed.

Furthermore, various settings or data stored within the controller device 103 may be made specific to individual family members and their personal devices. For example, where one family member desires a certain operational profile which is different from that of another, such profile may be readily recalled and implemented, somewhat akin to recalled settings for the driver's seat position of an automobile, as is well known in the control arts.

As referenced above, the exemplary systems 100, 101 of FIGS. 1a, 1b may use a variety of different distribution technologies, including: (i) low speed power line control over the house wiring, (ii) broadband transmission of audio/video or other content over power lines using HomePlug (HP), and later HomePlug audio/video (HP a/v); (iii) home phone network (HPN) over the house telephone wires for broadband home networking between computers with in the house and to the IP equipment; (iv) 802.11b/g wireless for connecting to notebook computers, PDAs, or other client devices for mobility around the premises; (v) pre- or post wired CAT-5/6 wiring for Ethernet and/or a/v using a/v baluns 150; (vi) coaxial cable distribution for RF/video/satellite/off-air applications; and (vii) Bluetooth wireless for, e.g., telephone or music headset and other short-range applications.

The present invention also provides exceptional scalability; the system is scalable from a small inexpensive “low-end” configuration having a limited number of control modules and features, to a larger high-end system with multi-room a/v entertainment systems and other such features. Hence, the systems 100, 101 are also advantageously user-configurable as well as scalable. That is, the user may self-upgrade or alter the capabilities and/or configuration of their system by simply adding or plugging in modules to the controller device 103 (or the remote units in the various rooms of the premises).

Advantageously, the exemplary systems 100, 101 are also self-repairable; the customer does not have to hire a costly technician to repair the system. Rather, the controller device 103 is configured to automatically detect the defective unit(s) or software using its self-diagnostic features. In one business model, replacement modules and components (including software upgrades) are made available from; inter alia, the manufacturer's Internet web site. The controller device 103 and systems 100, 101 as a whole is specifically adapted such that the customer may replace all defective modules. Specifically, with respect to the controller device 103, each module is connectorized, and simply slides out of the controller device 103. Optionally, the controller device 103 may also be placed in data communication with a remote service entity which may, run diagnostics (either periodically, or upon occurrence of one or more events or request from the customer) and diagnose failures in the system, thereby assisting the customer in his program needs. Such services may be provided free-of-charge, on a per-use pay basis, or via subscription, although other paradigms may be employed.

System components are also made user-installable, with the possible exception of wall plate replacement switches, dimmers and receptacles which may be installed by any electrician or handyman in the event that customer is not so skilled.

The systems 100, 101 are also made user-programmable by using simple setup functionality (e.g., simple GUI/menu structure or iconic representations), and intuitive prompting and/or scripting of the type well known in the UI arts. The systems 100, 101 may also be ordered by the customer in a fully programmed state based on inputs provided to the manufacturer or distributor; e.g., by answering a series of simple questions over the telephone, via a sales kiosk, via Internet, or even via mail-in survey.

As described in greater detail below, the system 100 also optionally employs software-based voice control from one or more microphones located, for example, in a camera assembly, handheld remote device, or dedicated modules with microphones, to control one or more of the controlled devices such as lights, HVAC, TV/stereo channels, door locks, etc. To further aid convenience, remote LCD (or other type) touches panel server controllers are provided for controlling the controller device 103, as well as HVAC control and even other functions. For example, the 10″, 6″ and 4″ portable touch screen devices described subsequently herein are used in the site kitchen, front entrance, bedroom, or other desired location. The monitors may also be used to access the Internet, e.g., for web searches and email.

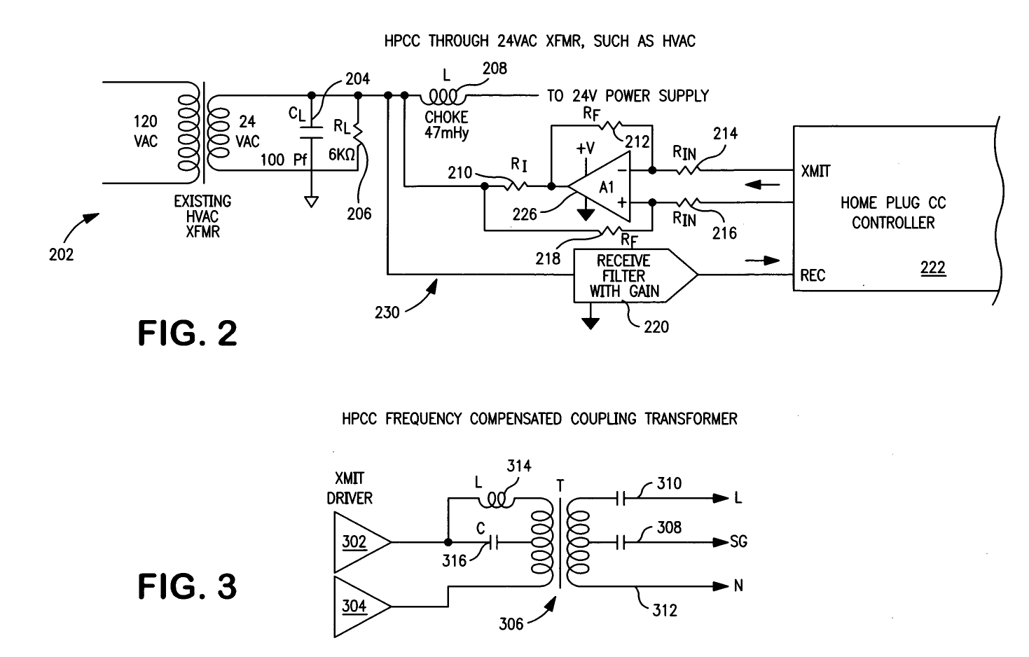

Referring now to FIG. 2, one exemplary embodiment of communication apparatus utilizing a drive circuit is described in greater detail.

### High Impedance Transformer Output Network

Most homes or other premises will include heating, ventilation and air conditioning (HVAC) functions which may be automated. A thermostat may be set via the LCD touch control or other user interface like any traditional thermostat, but the remote controller may also advantageously override and control the HVAC system(s). This allows for significant savings of power with very minimal installation effort and modification to the existing HVAC infrastructure at the premises.

As described above, a transformer, such as HVAC 202, communicates with a thermostat and other compatible devices (such as draperies, dampers, booster fans). In this embodiment, an HPCC driver amplifier 230 has been developed to minimize the transformer, e.g., HVAC 202, loss. In one embodiment the HVAC transformer, for instance HVAC transformer 202, is typically sector wound to achieve high voltage clearance between the primary (e.g., rated at 120 VAC) and a secondary region (e.g., rated at 24 VAC).

Unfortunately, the high voltage clearance results in high leakage inductance (e.g., a typical net leakage inductance on the 24V side is about 2 mHy). The high leakage inductance limits the bandwidth of the transformer, such as HVAC 202, and results in high insertion losses in the HPCC band. This leakage results essentially from a high output impedance (e.g., approximately 7 Kilo-ohms in the 100 K to the 400 K frequency range), so a termination when connecting to devices will be non-optimal and will result in high HPCC losses increasing with increasing frequency. In this embodiment, the secondary winding has an output termination including a shunt RL (e.g., in one preferred embodiment approximately 6 kilo-ohms) to minimize insertion loss, and a shunt CL (e.g., in one preferred embodiment approximately 100 pF) to equalize or remove ripples in the HPCC pass-band. In addition, the output termination enhances a resonance response with the leakage inductance, and also produces a second order LPF for upper band RF suppression. An inductor 208 is also provided to isolate the 24 VAC load in the HPCC band.

HPCC normally utilizes a voltage driver (not shown) to interface between the transformer 202 and the Home Plug Controller 222. In this embodiment, the HPCC driver 230 is a current source (e.g., including operational amplifier A1 226; Rf 212; Rin 214, 216; Ri 210, R1 218) to maintain a high impedance level while generating substantially equivalent high current drive for both forward and reverse transmission. The transformer 202 may also interoperate with a receive filter 220 that has a high impedance input and provides substantial gain. In summary, a net high impedance termination for the transformer 202 results from the sum of the following impedances: the HPCC driver amplifier 230, the receive filter 220, the RL 206 and the equivalent shunt impedance in the power choke 208. Because the overall circuit disclosed in FIG. 2 is substantially linear, circuit principles known to those of ordinary skill will show that the frequency response will be substantially similar for receive and the transmit directions.

Referring now to FIG. 3, one exemplary embodiment of a frequency compensated communication apparatus is described in greater detail.

### Frequency Compensated Communication Apparatus

Most of the homes power access nodes for light switches, fixtures or receptacles have varying impedance levels. The impedance levels for about 50 feet of house wiring from the circuit breaker panel may vary from about 10 ohms inductive at 100 KHz, to about 40 ohms inductive (4 times the initial impedance) at 400 KHz. In this embodiment, the line driver transformer 306 has a winding tap with a capacitor 316 and inductor 314 to vary the transformer 306 voltage ratio from 1 (at the lower frequency band, e.g., 100 KHz) to approximately 3-4 (at the upper frequency band, e.g., 400 KHz). This arrangement provides a transformer turns ratio that increases signal voltage on a line in the upper frequency band. As a consequence, this implementation provides a benefit of a more uniformly matched impedance level so that higher frequency communication may occur with a larger transmission levels and hence improved reliability and bandwidth.

In one preferred embodiment, L 314 has a value selected to adjust a turns ratio of the transformer 306 at a lower frequency band, e.g., approximately 100 KHz, and to limit short circuit current developed on driver amplifiers 302, 304. Furthermore, in this same preferred embodiment, a value of capacitance 316 is selected to control a transition level of a turn ratio from 1 to ohms as the operating frequency sweeps across the 100 K to 400 K frequency range. Note that for purposes of the above discussion, the nominal turns ratio was assumed to be 1:1; however, it will be recognized that depending on the driver's capability, this ratio may assume other values, such as 2:1, 3:1, and so forth.

In sum, the frequency dependent turns ratio produces higher transmission signals (levels) at higher frequencies.

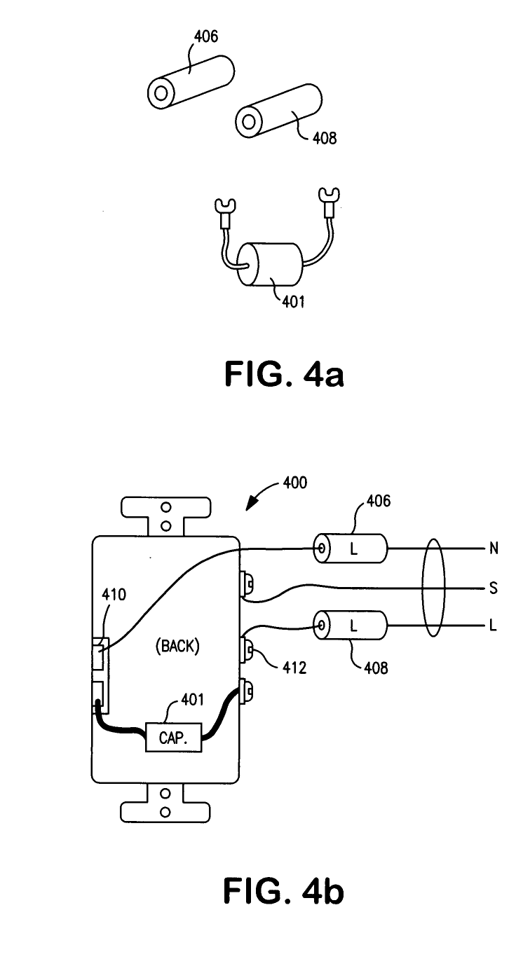

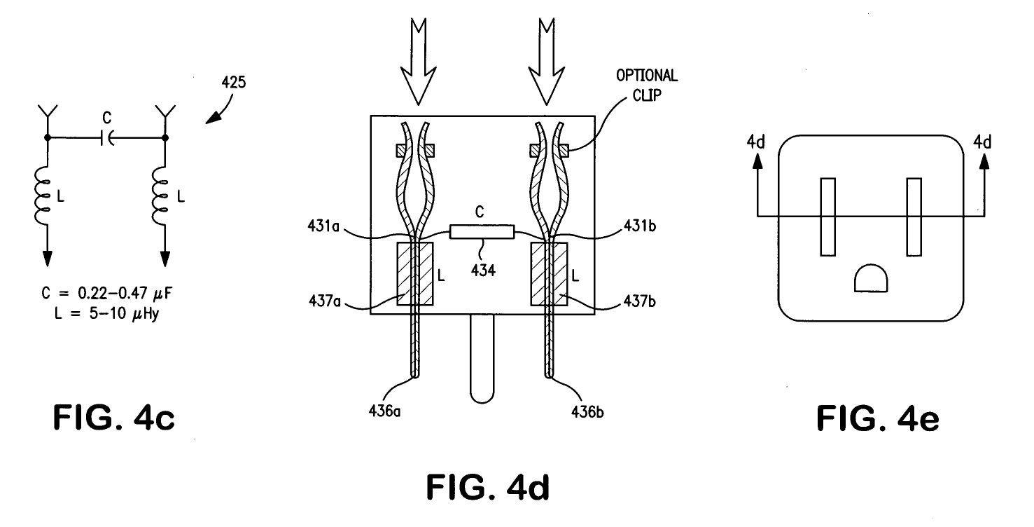

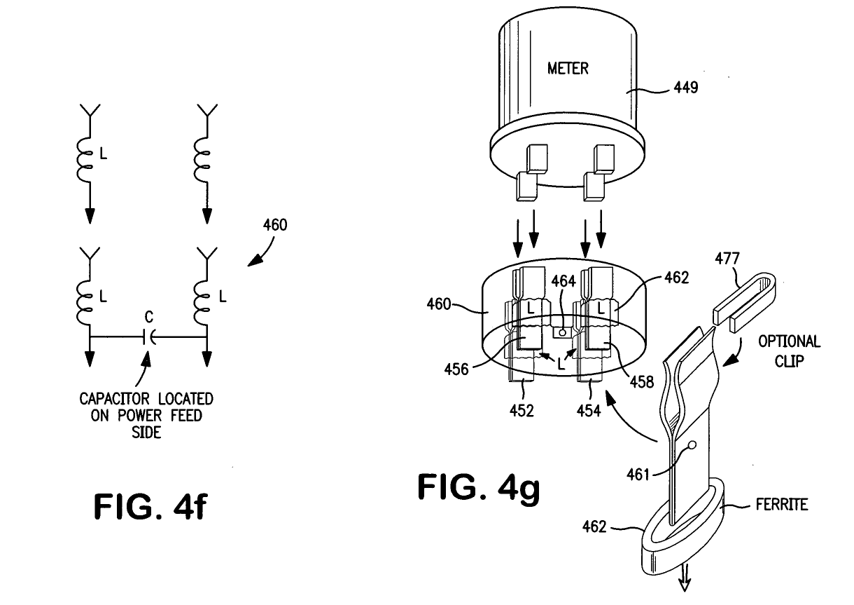

Referring now to FIGS. 4a-4c, exemplary embodiments of blocking filters described in greater detail.

### Blocking Filters

These filters may be used for, e.g., HomePlug, X-10, HomePlug a/v, and X-10 applications. While the illustrated circuits may be adapted for mounting within a standard wall-socket plug-in module of the type manufactured by the Assignee hereof, other configurations may be used.

In one embodiment, to prevent unauthorized access to the HPCC home network from outside a dwelling or commercial building via an outside receptacle 400, a filter may be added to the outside receptacle 400. Referring to FIGS. 4a and 4b, ferrites 406, 408 are slipped on (e.g. attached) to the Neutral (N) 402 and the Line (L) 404. In one preferred embodiment, inductor 406, 408, for example, are sleeves or toroids made of a high permeability ferrite and have a value of the high permeability ferrite selected to produce an inductance range of approximately 5 to 10 uHy. Capacitor 401 bridges across the receptacle 400 and attaches at connection points 410, 412 and electrically connects to the inductors 406, 408. Capacitor 401 and inductors 406, 408 values are chosen to move a resonance below 100 KHz (e.g., outside the active band, e.g., the HPCC passband). Another benefit of this filter is its ability to block interference from appliances utilizing the outside receptacle, such as receptacle 400, as well as block (e.g., isolate appliance load impedances, e.g., a low impedance appliance), which may load an HPCC home network and degrade network performance and/or increase power and/or voltage requirements.

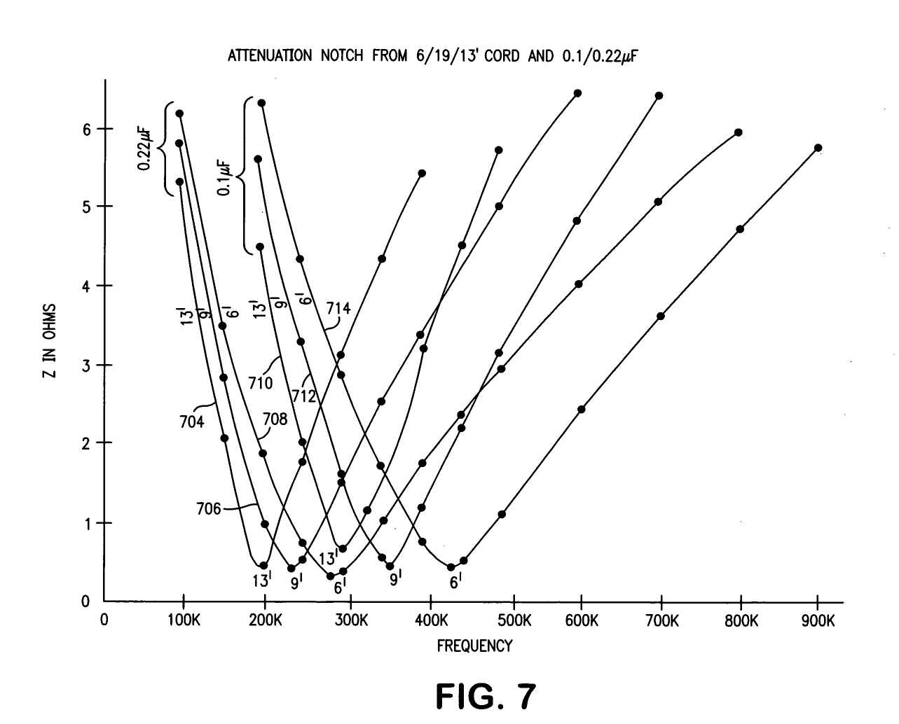

Another problem is when appliances generate switching noise that may saturate a receiver input of a powerline communication module, thereby, impairing signal transmission. An isolation filter 425 (shown in FIGS. 4c-4e) placed on the power input plug of any noisy appliance reduces switching noise provided at a receiver input. In yet another example, televisions and switching-mode power supply may utilize components that attenuate in-band frequency performance. For instance, if a device (such as Dev1 135a, or Dev2 135b) has an equivalent input capacitance (within a range of 0.1 uF to 0.47 uF) and connects to a 6-8 foot cord, an impedance notch may result in the HPCC frequency band that attenuates communications to and from an HPCC module (see FIG. 7). In this example, a low cost and very simple filter 425 applied to a device pushes an impedance notch, caused by internal components resonating with external components, to a lower frequency band than the HPCC frequency band.

In this example, the filter 425 is created using custom high permeability ferrites 437a, 437b that slide over the plug/jack terminals 436a, 436b. In one exemplary embodiment, the plug/jack terminals 436a, 436b are formed from a single bronze stamping that provides a plug at one end and connects to a receptacle at the other end and provides a capacitor connection terminals 431a, 431b (or alternatively may be a crimp hole) for the capacitor 434. In one preferred embodiment, the capacitor 434 is an AC capacitor within the range of 0.47-1 uF at 150 VAC, and the inductors 437a, 437b (e.g., in this example slip on ferrite cores) have an inductance value selected to produce a preferred inductance range of 5-10 uHy. In one alternative embodiment, housing for the filter 425 may be made using a single cavity to reduce overall costs.

In another embodiment, a filter has been developed to reduce powerline noise and signals that originates from either inside or outside a home or premises from passing either outside or inside a home or premises. One benefit of this filter is to reduce a level of signals passing from inside or outside a house passing outside or inside the house via a power feed. Referring to FIGS. 4f-4g, a filter assembly 460 (in an adapter that is approximately 1 inch thick) plugs into the meter plug to electrically connect the filter 460 between the meter 449 and a meter box (not shown). The filter 460, in one exemplary embodiment, is punched from a single stamping and folded to form a plug at one end, a socket at other end, and capacitor connection terminals 461 (or alternatively holes that connect to capacitor leads) to attach (e.g., using solder, or crimp leads) the capacitor 464. More than one capacitor may be used as necessary. A strong stainless steel contact tensioner 477 fitted across the receptacle ensures a reliable contact pressure. Molded, high permeability ferrite cores 462, for example, are fitted over the socket end of the terminals 452, 454, 456, 458 to provide an inductance that has a value selected, for example, from the preferred range of approximately 5-10 uHy. Insulating spacers (e.g., wafers or other insulating materials, not shown) sandwich the filter (e.g., ferrites 462 electrically coupled to capacitor 464) to secure the filter to the terminals 452, 454, 458, and 456. A significant design benefit of the invention includes that a self-installer may readily install the filter 460 (e.g., by or with the presence of a power company official).

It will be appreciated that other types (including orders) of filters may be used consistent with the invention. For example, a Chebyshev or other comparable filter may be used, and higher order circuits (e.g., third or even fourth order) may be used where the particular attributes of such circuits are desired.

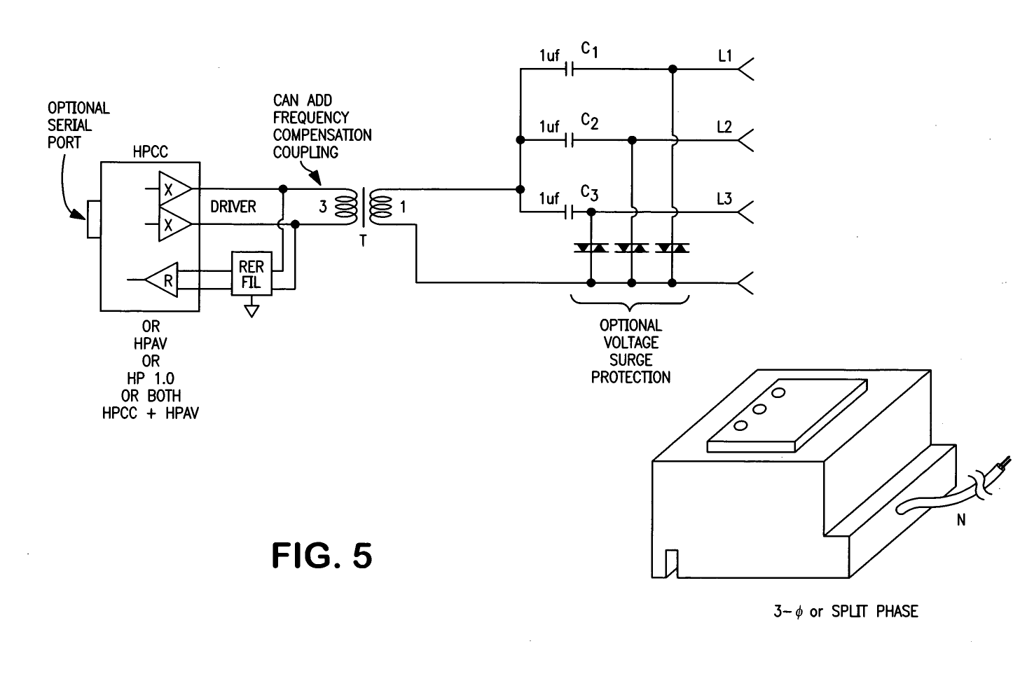

Referring now to FIG. 5, exemplary embodiments of a self-install phase repeater is described below.

### Phase Coupler and Repeater

For premises with a small number of electrical circuits and/or connections, no repeaters or couplers or SG/N transmission (clamps or ferrite chokes) may be required. Larger premises, especially including sub-panels and more complicated electrical wiring arrangements, may require a device to compensate for reduced transmission losses across the phases. First, a simple passive phase coupler is achieved using only capacitors C1, C2 and C3 of FIG. 5. Being passive, an input current from a device on one of the phases is simply split and applied across the other phases. Second, the repeater described herein may be readily adapted for many different systems including: 3-phase power plans, 2-phase plan of a 3 phase power system, or even as a split-phase repeater. Please note frequency compensation (as shown in FIG. 3) may be added at a primary winding of the transformer 508. In a conventional system, each phase at a circuit breaker box is less than one ohm at 100 KHz. At 100 KHs, coupling of the 3 phase lines at the transformer 508 causes very low impedance (less than one ohm).

In this exemplary embodiment, the 3 phase lines are capacitively coupled (using capacitors 510, 512, 514) to form a sensing node at transformer 508 secondary winding. In one preferred embodiment, the capacitors 510, 512, and 514 are selected from a preferred range of 0.47 uF-1 uF. In this exemplary embodiment, the transformer 508 having a 3:1 turns ratio provides current drive to the 3 phase lines. The 3:1 step up transformer steps up the receive voltage input to the receiver 504. In one preferred embodiment, installation of the repeater 500 is installed at a breaker panel, e.g., a main breaker panel. Consequently, the repeater may be modularly designed to plug into the main panel like a circuit breaker. In one variant, if the main breaker panel is full, a surge protector may be incorporated with the repeater 500 and remove an existing surge protector to create space in the panel. The repeater 500, in one example, may be programmed to repeat (e.g., a command) upon receiving a conformation. In yet another variation, the repeater 500 may include circuitry to perform other functional commands, associated with HomePlug 1.0, and HomePlug Turbo or HomePlug AV.

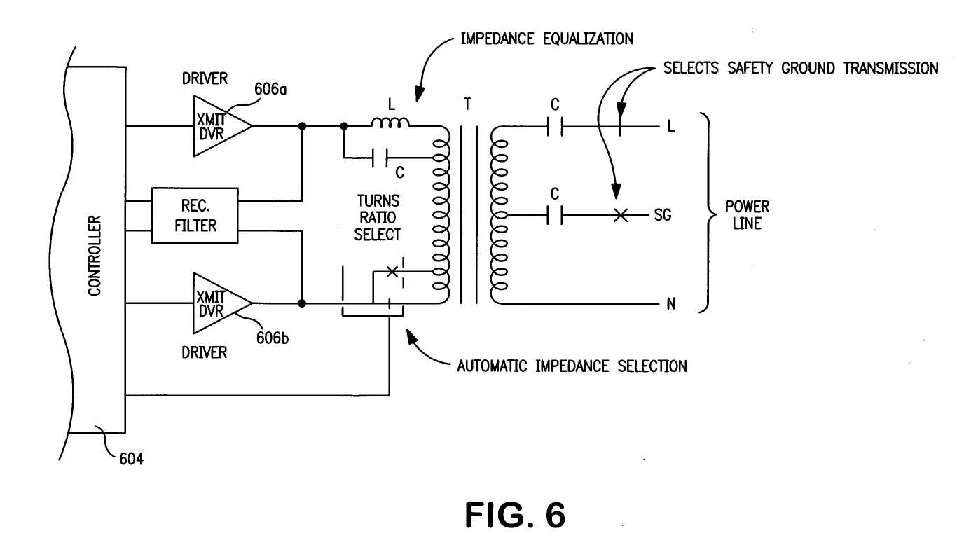

Referring now to FIG. 6, exemplary embodiments of an automated impedance selection is described below.

### Automated Impedance Selection

The power line impedance for e.g., a line 50 feet measured from the breaker panel varies in a home, and may be approximately 10 Ohms at 120 KHz. However, near the breaker box, impedance may drop below 1 Ohm. The controller device 604, e.g., HomePlug modules driver amplifiers 606a, 606b, transmits a signal, e.g., around 120 KHz, and measures a feedback signal. A level of the feedback signal is compared to that of a transmit signal. The comparison results in determining a line impedance of a connected device. If the line impedance is below pre-determined impedance, e.g., 2-3 Ohms, the controller device 604 communicates to increase the turns ratio of the transformer 614 to more closely match an impedance of the connected device (e.g., around 1-3 ohms). As a result of improved impedance matching, frequency powerline communication reliability and efficiency are improved because more current/voltage is applied to the line.

Referring now to FIG. 7, exemplary embodiments of an automated impedance selection is described below.

### Notch Detection

In many systems, televisions or appliances with switch mode power supplies use an internal converter supply filter capacitor, e.g., in a range of 0.1-0.47 uF, located at the converter. When a six foot (6′) or so power cord is connected to the internal capacitor, a line cord impedance notch occurs. In particular, curve 708 represents frequency performance when an exemplary six foot power cord is connected to a 0.22 uF capacitor. In addition, curve 714 represents performance when a six foot power cord is connected to a 0.1 uF capacitor. In other examples, curves 704 (using a 13′ long cable) and 706 (using 9′ long cable) display a frequency notch around 250 K upon being connected to a load capacitance of 0.22 uF capacitor. Furthermore, curves 710 (using a 13′ long cable), 712 (using a 9′ long cable), respectively depict a frequency notch around 350 K when each is connected to a load capacitance of 0.1 uF. Consequently, a frequency dependent impedance notch is created when a power cord is attached next to a HPCC device, which may cause degraded communication performance.

In this embodiment, to detect a location of a frequency notch, a HPCC module processor communicates a sweep signal across an operating frequency range, e.g., 120 KHz to 400 KHz to an electrical device, measures receive input response to determine impedance levels across a band, and to identify a location of a frequency notch. In particular, upon receiving a measurement (from the HPPC module processor) that an impedance level is decreasing as the frequency sweeps from increases 100 KHz to 200 KHz, the self installer realizes that a frequency notch is about to occur. Once a frequency notch drops below a user or administrator designated threshold, e.g., 2 Ohms, a receive input response is displayed, e.g., as a flashing LED or indicator, to the self-installer who is instructed to install an appliance filter on the offending appliance.

Furthermore, if an HPCC module plugged into a receptacle has a very high level noise source that saturates a receiver input, a self-installer may not be able to locate the offending appliance device. In this situation, the offended HPCC module will scan the receive input, determine if the line noise is above operating levels of the module, and, recommend placing an appliance filter to the self-installer on the closest offending appliance.

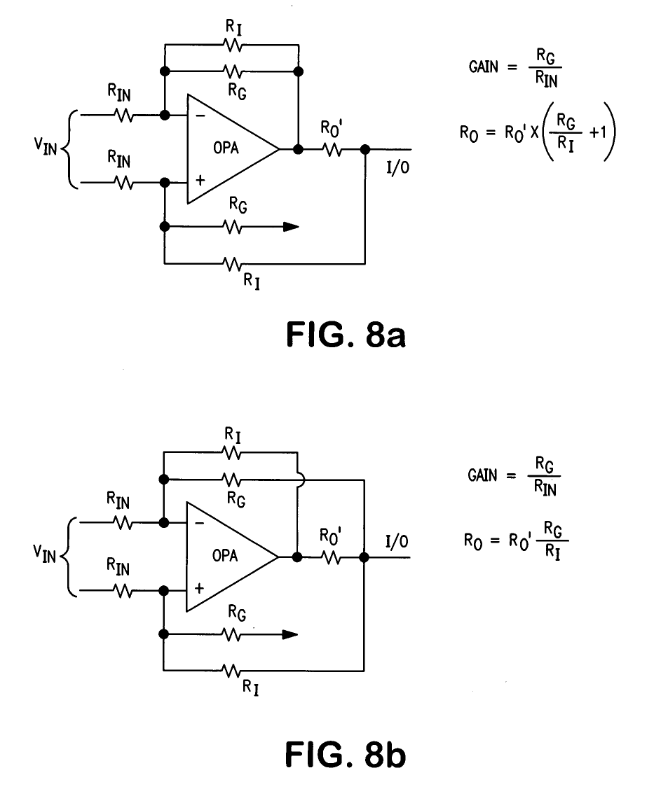

Referring now to FIGS. 8a, 8b, exemplary embodiments of an active output resistance is described below.

Driver with Active Output Resistance

Active output resistance (Ro) may almost cut in half the power supply power and voltage requirements for a line driver. Typically, a low output resistance of a driver amplifier (e.g., driver amplifier 800 or 801) may sacrifice up to half of the power supply voltage (e.g., V+) across a heavy load, such one provided by an appliance or being close to the breaker panel. The output resistance (Ro′) limits maximum current of a driver amplifier (e.g., driver amplifier(s) 800, 801) to prevent overheating.

Referring to FIG. 8a, The driver amplifier 800 utilizes a driver power operational amplifier (OPA) 802 with gain resistor of (Rf) 805 and an input resistance Rin 808 to set the amplifier gain at a ratio of (Rf/Rin+1) with an output resistance of (Ro) 810. Referring to FIG. 8b, the driver amplifier 801 utilizes a driver power operational amplifier (OPA) 802 with gain resistor of (Rf) 805 and (Rin) 808 that sets amplifier gain at a ratio of (Rf/Rin) with an output resistance of (Ro) 810. Feedback resistors (RI) 812 sense output current through sensing voltage across (Ro′) 814 and amplify a sensing voltage to produce a positive feedback signal that is received at the output. The positive feedback signal creates an effective multiplying of the output resistance (Ro′) to (Ro′×Rf/R1).

In either of the above embodiments, the actual output resistance being smaller than the active resistance of the driver amplifiers 800, 801 causes less voltage drop and less power lost; thus, the driver amplifiers 800, 801 lower power supply voltage requirements (up to half) as compared to a conventional low output impedance amplifiers.

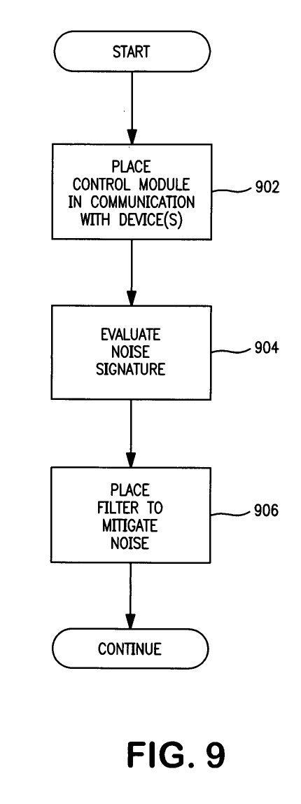

Referring now to FIG. 9, exemplary methods for determining noise of a device and placing appliance filters is described below.

In step 902, a control module (e.g., the command control module 102) is placed in communication with one or more electrical devices 153a, 153b. A noise detection circuit is next used to evaluate the power level of a receive circuit coupled to the command control module 102 (step 904) for inter alia its noise level or signature. In step 906, the command control module 102 determines that an appliance filter (such as those in FIGS. 4a-c) should be placed on at least one of the devices detected as having a high noise level. This may be done by e.g., signaling a self-installer to place the filter, switching the filer in automatically, etc.

In another variant, the foregoing method may include measuring the level of electrical signals from inside a unit that are communicated outside of the unit, and causing (e.g., signaling a self-installer to cause) placement of a second appliance filter (such as those depicted in FIGS. 4a-4c) on at least one of the plurality of devices 153a, 153b detected as communicating a high leakage signal outside of the unit.

In another variant, the second appliance filter (such as those depicted in FIGS. 4a-4c) may comprise at least two ferrite core adapters (e.g., inductors 406, 408) disposed about external connectors; and a capacitive device (e.g., 401) adapted to operatively couple and detachably connect between the at least two ferrite core adapters (e.g., inductors 406, 408).

In still another variant, the HPCC device is configured to measure line noise and determine if this noise is too large (such as in magnitude, and/or based on frequency band), and also determine the character or signature thereof. Depending on the signature, the HPCC device can tell the installer (using e.g., a flashing LED or another such indication or user interface) to take action, such as e.g., installing a filter on a device with a switching power supply such as for example a computer flat panel display.

It will be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

What is claimed is:

1. An apparatus comprising:
a controller device to provide electrical command signals to a plurality of devices coupled to a powerline; and
wherein said controller is operatively coupled to a non-signal line to provide a communication path to the plurality of devices.

2. The apparatus of claim 1, wherein said operative coupling comprises a transformer operatively coupled to the controller device and configured to capacitively couple through its center tap to the non-signal line.

3. The apparatus of claim 1, wherein the non-signal line comprises at least one safety ground.

4. The apparatus of claim 1, wherein the non-signal line comprises at least one neutral line.

5. The apparatus of claim 1, further comprising a choke coupled between the non-signal line and a neutral line to provide a substantially electrically isolated summing node.

6. The apparatus of claim 5, wherein the non-signal line comprises at least one safety ground.

7. The apparatus of claim 1, further comprising a wire clamp to bundle a plurality of safety ground lines to create at least one isolated summing node.

8. The apparatus of claim 7, further comprising an inductive device coupled between the wire clamp and a neutral termination to create an isolated summing node to tie together a plurality of safety ground lines.

9. The apparatus of claim 1, further comprising a ferrite core coupled to the non-signal line to create an inductive termination of the non-signal line to a neutral line.

10. The apparatus of claim 9, wherein the ferrite core comprises two half cores that couple about the non-signal line to create a low noise communication path.

11. The apparatus of claim 1, wherein the non-signal line and at least one signal line are utilized to communicate with the plurality of devices.

12. The apparatus of claim 1, further comprising a frequency compensation network to provide an increased voltage level to upper frequency band signals than those of lower frequency band signals.

13. The apparatus of claim 2, further comprising a frequency compensation network that is operatively coupled to a primary winding of the transformer to provide an increased voltage level to upper frequency band signals than those of lower frequency band signals.

14. An apparatus comprising:
a module configured to communicate electrical signals to a plurality of electrical devices coupled to a power line; and
a first transformer having a primary and a secondary winding and turns ratio a/b;
wherein the turns ratio a/b comprises a frequency dependant portion to provide a high impedance termination network and to allow the module to communicate with substantially similar performance in both a receive mode as a transmit mode.

15. The apparatus of claim 14, wherein the module comprises an HPCC module, and the first transformer comprises an existing transformer.

16. The apparatus of claim 14, wherein the apparatus is adapted to operate on a 24V system.

17. The apparatus of claim 14, wherein the secondary winding comprises a shunt capacitance used to flatten a frequency response of the electrical signals, to be resonant with leakage inductance of the first transformer, and to suppress spurious RF signals.

18. The apparatus of claim 14, further comprising a current source coupled between the high impedance termination network and the module to maintain high impedance level and generate high drive current for reverse transmission.

19. The apparatus of claim 14, wherein the module comprises:
a controller device;
a second transformer operatively coupled to the controller device and configured to capacitively couple through a center tap to a safety ground line to provide a communication path to the plurality of electrical devices and to provide a reduce system noise floor;
a wire clamp adapted to bind adjacent safety ground lines; and
a choke coupled between the wire clamp and a connection node to a neutral line;
wherein the wire clamp provides a substantially electrically isolated summing node for the adjacent safety ground lines.

20. An apparatus comprising:
a controller device to provide electrical command signals to a plurality of devices coupled to a powerline; and
a transformer operatively configured to provide a frequency dependant turns ratio to the plurality of devices to provide increased voltage levels to higher frequency signals than that of a lower frequency signal band.

21. An apparatus comprising:
a command control module to communicate with at least one electrical device; and
a notch detection circuit adapted to communicate a sweep signal across a designated frequency band, to measure a receive input response, and to determine an impedance across the designated frequency band; and
an appliance filter adapted to shift outside the designated frequency band at least a portion of the receive input response that comprises a low impedance response.

22. A method comprising:
communicating with a command control module to a plurality of electrical devices;
scanning with a noise detection circuit a power level of a receive circuit coupled to the command control module; and
signaling a self-installer to place a first appliance filter on at least one of the plurality of electrical devices detected as having a high noise level.

23. The method of claim 22 further comprising the steps of:
measuring a level of electrical signals from inside a unit communicated to outside of the unit;
signaling a self-installer to place a second appliance filter on at least one of the plurality of electrical devices detected communicating to outside of the unit a high leakage signal.

24. The method of claim 23, wherein the second appliance filter comprises:
(i) at least two ferrite core adapters disposed about external connectors; and
(ii) a capacitive device adapted to operatively couple and detachably connect between the at least two ferrite core adapters.

25. A filter apparatus, comprising:
a plurality of terminals;
at least one capacitor disposed electrically between two of said terminals;
a plurality of ferrite elements, each of said elements being disposed substantially proximate respective ones of said terminals; and
at least one insulating substrate having apertures through which a portion of each of respective ones of said terminals project.

26. The apparatus of claim 25, wherein said filter apparatus is used in a metering application and is adapted to substantially prevent at least some noise from passing between the interior and exterior of a premises power system.

27. The apparatus of claim 25, wherein said terminals each comprise a substantially unitary metallic piece that is folded to form a receptacle for a terminal pin or blade.

28. The apparatus of claim 27, wherein said terminals each further comprise a clip adapted to fit over at least a portion of said folded terminal and provide at least some degree of tension or resistance for said pin or blade when inserted into said receptacle.

29. The apparatus of claim 27, wherein at least two of said terminals are coupled to said capacitor via a crimp or solder joint.

30. The apparatus of claim 25, wherein said ferrite elements comprise molded high permeability ferrite cores having an aperture formed therein, at least a portion of respective ones of said terminals being disposed within said aperture.

31. The apparatus of claim 30, wherein said ferrite elements each produce an inductance of approximately 5-10 uHy.

32. The apparatus of claim 25, wherein said at least one substrate comprises two insulating wafers that sandwich at least a portion of the terminals and their associated ferrites and the capacitor.
